(19) United States
(12) Patent Application Publication
(10) Pub. No.: US 2021/0081900 A1
(43) Pub. Date: Mar. 18, 2021

(54) IDENTIFYING JOB SEEKERS

(71) Applicant: Microsoft Technology Licensing, LLC, Redmond, WA (US)

(72) Inventors: Xiaoqing Wang, San Jose, CA (US); Samaneh Abbasi Moghaddam, Sunnyvale, CA (US); Xiaowen Zhang, Santa Clara, CA (US)

(73) Assignee: Microsoft Technology Licensing, LLC, Redmond, WA (US)

(21) Appl. No.: 16/569,915

(22) Filed: Sep. 13, 2019

(51) Int. Cl. G06Q 10/10; G06N 20/00; G06N 5/04; G06Q 50/00

(52) U.S. Cl. CPC G06Q 10/1053; G06Q 50/01; G06N 5/04; G06N 20/00

(57) ABSTRACT

The disclosed embodiments provide a system for identifying job seekers. During operation, the system determines, based on data retrieved from a data store in an online system, profile features produced from profile attributes in a profile of a first member in the online system and activity features produced from activity attributes that characterize activity of the first member with the online system. Next, the system applies a machine learning model to the profile features and the activity features to produce a score representing a likelihood that the first member is a job seeker. The system then applies a threshold to the score to generate a classification of the first member as the job seeker or as a non-job-seeker. Finally, the system updates, based on the classification, content outputted in a user interface of the online system by one or more electronic devices.

### BACKGROUND

### Field

The disclosed embodiments relate to techniques for identifying job seekers.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for identifying job seekers in an online system in accordance with the disclosed embodiments.

FIG. 3 shows a flowchart illustrating a process of identifying job seekers in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing content and/or user interfaces in online systems. For example, the content include jobs and/or other opportunities that are posted within an online system such as an online network and/or online marketplace. The user interfaces include graphical user interfaces (GUIs), web-based user interfaces, and/or other types of interfaces that allow members of the online system to access the content and/or features in the online system from computer systems, mobile devices, gaming consoles, televisions, home assistants, and/or other network-enabled electronic devices.

More specifically, the disclosed embodiments provide a method, apparatus, and system for identifying job seekers in an online system. In these embodiments, job seekers include members of the online system who are likely to engage with job-seeking content, actively looking for jobs or opportunities, and/or open to new jobs or opportunities. A set of rules is used to identify some members as job seekers based on job-seeking activity and/or user settings of the members within the online system. For example, the rules identify job seekers as members that have performed at least two job searches, applied to one job, saved one job, and/or set one job alert over the past four weeks. In another example, the rules identify job seekers as members that have signaled openness to new jobs or opportunities in the online system (e.g., as user preferences or settings).

Additional members of the online system are also identified as job seekers based on similarities with job seekers identified using the rules. For example, a first set of members identified as job seekers by the rules is assigned a first (e.g., positive) label, and a second set of members with no job-seeking activity over the same window is assigned a second (e.g., negative) label. The labels and features associated with the first and second sets of members are inputted as training data for a machine learning model, with the features including profile features related to attributes of the members' profiles in the online system and activity features related to the members' activity within (or outside) the online system. The trained machine learning model is applied to features for additional members of the online system to generate scores representing the likelihoods that the members are job seekers, and a threshold is applied to the scores to classify each of the members as a job seeker or a non-job-seeker.

Finally, the scores and/or classifications are used to update the user interface and/or user experience associated with the online system. For example, the classification of each member as a job seeker or non-job-seeker is inputted with additional features into another machine learning model that predicts an outcome between the member and a job (or other type of opportunity). The output of the other machine learning model is then used to rank members as potential candidates for the job or to rank the jobs as potential recommendations for the member, and some or all of each ranking is outputted in a user interface, message, email, notification, and/or another mechanism for interacting with the online system.

By identifying members as job seekers based on job-seeking activity and/or similarity to other job seekers, the disclosed embodiments streamline processing by the online system and/or interactions between the members and the online system. More specifically, the online system is able to increase job-related interactions and recommendations for members that are job seekers and decrease job-related interactions and recommendations for members that are not interested in jobs or opportunities. Because members identified as job seekers are more likely to be interested in jobs or opportunities than members identified as non-job-seekers, the online system reduces the amount of processing, querying, storage, network, and/or other overhead required to find, contact, or hire qualified candidates for the jobs. The online system further reduces the generation of job-related recommendations, notifications, messages, emails, features, and/or other types of processing or storage for members that are identified as uninterested in job seeking.

In contrast, conventional techniques use explicit job-seeking activity, settings, or preferences to identify job seekers, resulting in the misidentification of some users as non-job-seekers when the users are interested in new jobs or opportunities. The misidentified users may be ranked lower than other candidates for jobs and/or omitted from job-related recommendations or communications, which in turn increases the amount of processing and/or storage required to find candidates that are interested in the jobs and/or hire successfully for the jobs. At the same time, the usability and/or value of hiring, job search, and/or employment tools or applications is negatively impacted. Consequently, the disclosed embodiments may improve computer systems, applications, user experiences, tools, and/or technologies related to generating search results, user recommendations, employment, recruiting, and/or hiring.

### Identifying Job Seekers

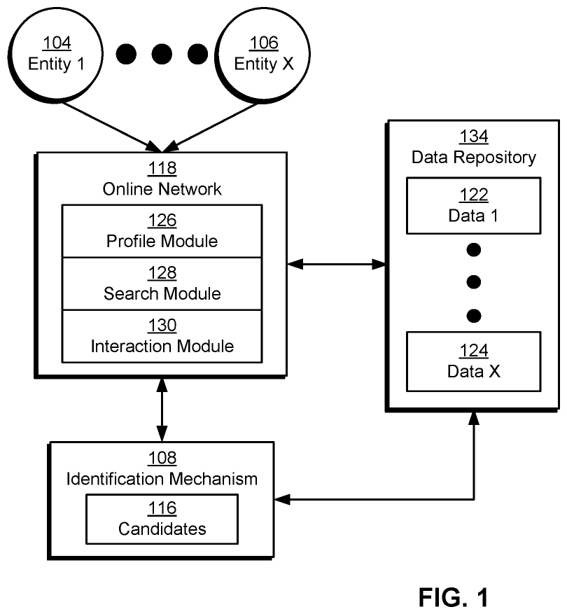

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 are inputted into the machine learning model(s), along with features and/or characteristics of the corresponding opportunities (e.g., required or desired skills, education, experience, industry, title, etc.). In turn, the machine learning model(s) output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) further adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

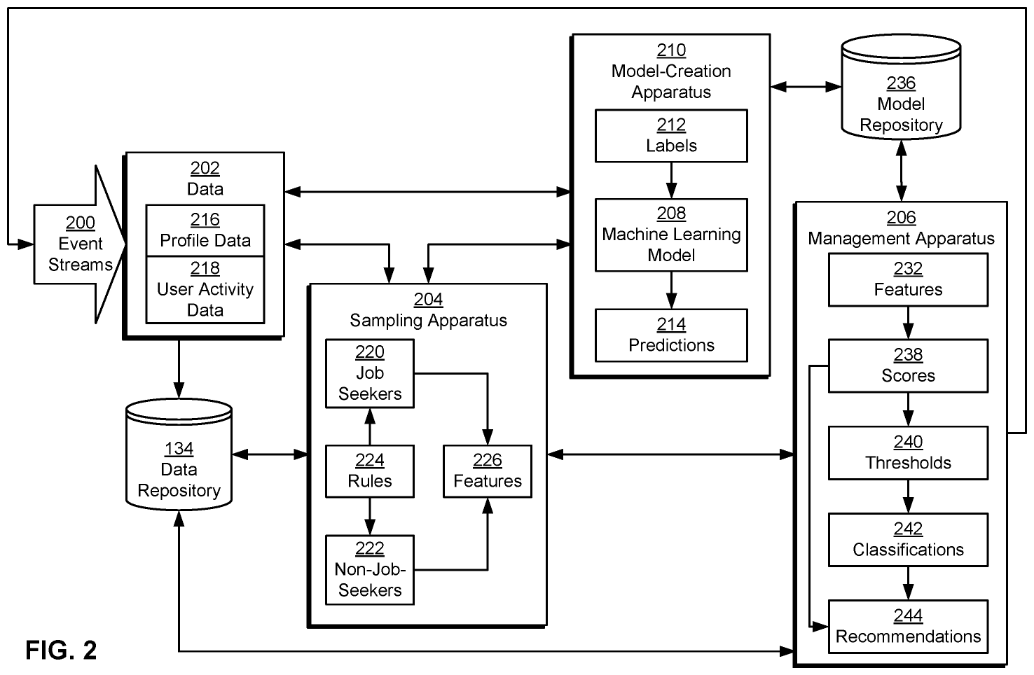

In one or more embodiments, online network 118 includes functionality to improve delivery of jobs (or other content), outcomes related to the jobs, and/or the performance and use of online network 118 by classifying candidates 116 and/or other members of online network 118 as job seekers or non-job-seekers. As shown in FIG. 2, data repository 134 and/or another primary data store are queried for data 202 that includes profile data 216 for members of an online system (e.g., online network 118 of FIG. 1), as well as user activity data 218 that tracks the members' activity within and/or outside the online system.

Profile data 216 includes data associated with member profiles in the online system. For example, profile data 216 for an online professional network includes a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 also, or instead, includes a set of groups to which the user belongs, the user's contacts and/or connections, and/or other data related to the user's interaction with the online system.

Attributes of the members from profile data 216 are optionally matched to a number of member segments, with each member segment containing a group of members that share one or more common attributes. For example, member segments in the online network may be defined to include members with the same industry, title, location, and/or language.

Connection information in profile data 216 is optionally combined into a graph, with nodes in the graph representing entities (e.g., users, schools, companies, locations, etc.) in the online system. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the online system. For example, user activity data 218 may be used to track impressions, clicks, likes, dislikes, shares, hides, comments, posts, updates, conversions, and/or other user interaction with content in the online system. User activity data 218 may also, or instead, track other types of activity, including connections, messages, job applications, job searches, setting job alerts, recruiter searches for candidates, interaction between candidates and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users. Like profile data 216, user activity data 218 may be used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, data repository 134 stores data that represents standardized, organized, and/or classified attributes in profile data 216 and/or user activity data 218. For example, skills in profile data 216 and/or user activity data 218 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the online system is generated in response to the activity. The record is then propagated to components subscribing to event streams 200 on a nearline basis.

A sampling apparatus 204 uses a set of rules 224 to identify a first set of members of the online system as job seekers 220 and a second set of members of the online system as non-job-seekers 222. In some embodiments, job seekers 220 include members of the online system that are likely to engage with job-seeking content, are actively looking for jobs or opportunities, and/or have expressed an intent to look for jobs or opportunities.

In one or more embodiments, rules 224 specify recent attributes and/or activity that are indicative of job seekers 220. First, rules 224 identify job seekers 220 as members that meet threshold amounts of job-seeking activity within (or outside) the online system. For example, rules 224 specify that a member is a job seeker if the member has at least one job application, one job save, one job alert set, and/or two job searches over a configurable and/or sliding time window (e.g., the last several weeks or month).

Second, rules 224 identify job seekers 220 as members that have specified openness to new jobs or opportunities. For example, the online system includes functionality to allow members to specify job seeking preferences. Within the job seeking preferences, a member can explicitly indicate his/her openness to jobs or opportunities, which allows the member to appear in searches for candidates by recruiters and/or job posters in the online system. As a result, rules 224 may specify classification of members that self-identify as open to jobs or opportunities as job seekers 220 over the configurable and/or sliding time window.

Third, rules 224 identify non-job-seekers 222 as members that lack job-seeking activity within the same window used to identify job seekers 220. For example, rules 224 may specify that a member is a non-job-seeker if he/she has not had any job views, job searches, job saves, job applications, job alerts set, or other job-related activity over the sliding and/or configurable time window.

Next, sampling apparatus 204 generates and/or retrieves features 226 for job seekers 220 and non-job-seekers 222. In some embodiments, features 226 are generated from profile data 216 and user activity data 218 collected over the same time window used to identify job seekers 220 and non-job-seekers 222. For example, features 226 reflect profile data 216 and user activity data 218 by job seekers 220 and non-job-seekers 222 over the span of several weeks or a month that was used to identify job seekers 220 and non-job-seekers 222, based on the corresponding job-related activity or lack of job-related activity.

In one or more embodiments, features 226 include profile features generated from profile data 216 of job seekers 220 and non-job-seekers 222, as well as activity features generated from user activity data 218 for job seekers 220 and non-job-seekers 222. Profile features associated with job seekers 220 and non-job-seekers 222 include attributes, fields, aggregations, metrics, and/or other representations of profile data 216. For example, the profile features include standardized titles, industries, locations, languages, seniorities, schools, degrees, fields of study, companies, skills, and/or other fields in member profiles of job seekers 220 and non-job-seekers 222. The profile features also, or instead, include aggregations of fields in profile data 216, such as counts of positions, skills, and/or companies followed in a given member's profile; the length of the member's career, as specified in the profile (e.g., the number of years of experience listed in the profile); and/or a score representing the “completeness” of the profile.

Activity features associated with job seekers 220 and non-job-seekers 222 include attributes, fields, aggregations, metrics, and/or other representations of user activity data 218. For example, the activity features include, for a given member, counts of page views, user sessions, profile edits, views of other members' profiles by the member, views of the member's profile by other members, views of the member's profile by the member, job views, job searches, searches, messages sent and/or received, job applications, and/or active members in the member's network. The activity features also, or instead, include the recency of (e.g., number of days since) a job search, job view, job application, profile edit, and/or other types of job-related or non-job-related activity by the member in the online system.

Sampling apparatus 204 and/or another component of the system also assign labels 212 to features 226 for job seekers 220 and non-job-seekers 222. For example, sampling apparatus 204 assigns one label to features 226 for job seekers 220 and a different label to features 226 for non-job-seekers 222.

A model-creation apparatus 210 uses training data from sampling apparatus 204 to create and/or update a machine learning model 208. For example, model-creation apparatus 210 inputs features 226 and labels 212 for job seekers 220 and non-job-seekers 222 identified by sampling apparatus 204 into a gradient-boosted tree and/or another type of machine learning model 208. Model-creation apparatus 210 then uses a training technique and/or one or more hyperparameters to update parameters of filtering model 208 so that predictions 214 outputted by machine learning model 208 better reflect labels 212 for the corresponding features 214.

In one or more embodiments, each prediction outputted by machine learning model 208 represents the likelihood that a corresponding member is a job seeker. For example, machine learning model 208 outputs scores 238 ranging from 0 to 1. A higher score indicates a higher likelihood that a member is a job seeker, and a lower score indicates a lower likelihood that a member is a job seeker. As a result, model-creation apparatus 210 trains machine learning model 208 to output a score that is close to 1 when the member has a positive label of 1 and a score that is close to 0 when the member has a negative label of 0.

After machine learning model 208 is created and/or updated, model-creation apparatus 210 stores parameters of machine learning model 208 in a model repository 236. For example, model-creation apparatus 210 may replace old values of the parameters in model repository 236 with the updated parameters, or model-creation apparatus 210 may store the updated parameters separately from the old values (e.g., by storing each set of parameters with a different version number of machine learning model 208).

A management apparatus 206 obtains a representation of machine learning model 208 from model-creation apparatus 210, model repository 236, and/or another source. Next, management apparatus 206 applies machine learning model 208 to features 232 for additional members to generate scores 238 for the members. Management apparatus 206 then applies one or more thresholds 240 to scores 238 to generate classifications 242 of the additional members as job seekers 220 or non-job-seekers 222 and outputs recommendations 244 based on classification 242.

For example, management apparatus 206 obtains, from sampling apparatus 204 and/or another component, features 232 for members that could not be classified as job seekers 220 or non-job-seekers 222 by sampling apparatus 204. Management apparatus 206 applies machine learning model 208 to features 232 for each member to generate a score (e.g., scores 238) from 0 to 1 representing the member's likelihood of being a job seeker. Management apparatus 206 then compares the score with a numeric threshold that is selected to optimize for precision, recall, and/or other performance metrics related to machine learning model 208. If the score meets or exceeds the threshold, management apparatus 206 classifies the member as a job seeker. If the score does not meet or exceed the threshold, management apparatus 206 classifies the member as a non-job-seeker.

Continuing with the above example, management apparatus 206 stores and/or outputs scores 238 and classifications 242 in conjunction with identifiers for the corresponding members. Management apparatus 206 also, or instead, inputs scores 238 and/or classifications 242 into additional machine learning models to generate recommendations 244 between the members and jobs and/or otherwise perform targeting of the members with job-related content or features. Such recommendations 224 include, but are not limited to, job recommendations for members that are identified to be job seekers 220, sponsored content related to the members' careers and/or job-seeking interest, salary notifications for the members, and/or recommendations 224 of job seekers 220 to recruiters or other moderators of jobs in the online system. Subsequent responses to recommendations 224 may, in turn, be used to generate events that are fed back into the system and used to update features 226 and 232, rules 224, labels 212, machine learning model 208, scores 238, thresholds 240, classifications 242, and/or recommendations 244.

By identifying members as job seekers based on job-seeking activity and/or similarity to other job seekers, the disclosed embodiments streamline processing by the online system and/or interactions between the members and the online system. More specifically, the online system is able to increase job-related interactions and recommendations for members that are job seekers and decrease job-related interactions and recommendations for members that are not interested in jobs or opportunities. Because members identified as job seekers are more likely to be interested in jobs or opportunities than members identified as non-job-seekers, the online system reduces the amount of processing, querying, storage, network, and/or other overhead required to find, contact, or hire qualified candidates for the jobs. The online system further reduces the generation of job-related recommendations, notifications, messages, emails, features, and/or other types of processing or storage for members that are identified as uninterested in job seeking.

In contrast, conventional techniques use explicit job-seeking activity, settings, or preferences to identify job seekers, resulting in the misidentification of some users as non-job-seekers when the users are interested in new jobs or opportunities. The misidentified users may be ranked lower than other candidates for jobs and/or omitted from job-related recommendations or communications, which in turn increases the amount of processing and/or storage required to find candidates that are interested in the jobs and/or hire successfully for the jobs. At the same time, the usability and/or value of hiring, job search, and/or employment tools or applications is negatively impacted. Consequently, the disclosed embodiments may improve computer systems, applications, user experiences, tools, and/or technologies related to generating search results, user recommendations, employment, recruiting, and/or hiring.

Those skilled in the art will appreciate that the system of FIG. 2 may be implemented in a variety of ways. First, sampling apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Sampling apparatus 204, model-creation apparatus 210, and management apparatus 206 may additionally be implemented together and/or separately by one or more hardware and/or software components and/or layers.

Second, a number of models and/or techniques may be used to generate scores 238, classifications 242, and/or recommendations 244. For example, the functionality of machine learning model 208 may be provided by one or more regression models, artificial neural networks, support vector machines, decision trees, random forests, gradient boosted trees, naïve Bayes classifiers, Bayesian networks, clustering techniques, collaborative filtering techniques, deep learning models, hierarchical models, and/or ensemble models. In another example, management apparatus 206 uses scores 238 and/or classifications 242 as additional features that are inputted into other machine learning models and/or a multi-objective optimization technique that generates recommendations 244 related to the corresponding members.

The retraining or execution of machine learning model 208 may also be performed on an offline, online, and/or on-demand basis to accommodate requirements or limitations associated with the processing, performance, or scalability of the system and/or the availability of features used to train the machine learning model. Multiple versions of machine learning model 208 and/or thresholds 240 may further be adapted to different subsets of members (e.g., different member segments), or the same machine learning model and/or threshold may be used to generate scores 238 and/or classifications 242 for all members.

Third, the system of FIG. 2 may be adapted to different types of members, opportunities, content, features and/or recommendations 244. For example, machine learning model 208 may be used to generate scores 238, classification 242, and/or recommendations 244 related to user engagement with or interest in articles, mentorship opportunities, scholarships, fellowships, classes, products, services, new connections, online marketplaces, and/or other content or features of the online system.

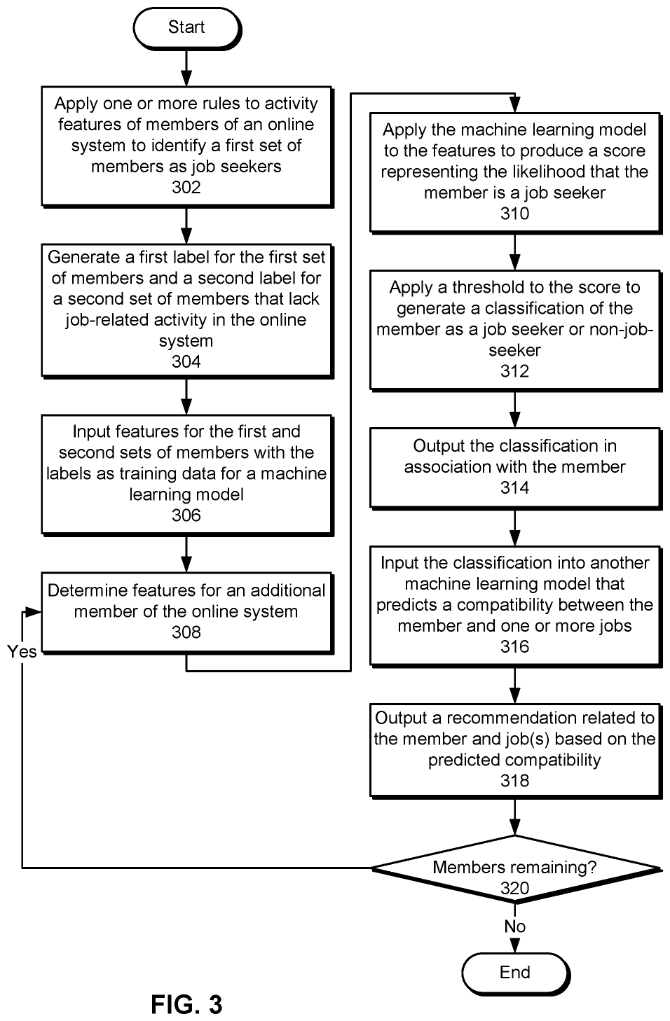

FIG. 3 shows a flowchart illustrating a process of identifying job seekers in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, one or more rules are applied to activity features of members of an online system to identify a first set of the members as job seekers (operation 302). For example, the rules specify that a member is a job seeker if the member has performed at least one job application, saved one job, set one job alert, and/or performed two job searches in a recent number of weeks and/or another pre-specified period. The rules also, or instead, identify job seekers as members that have a user-specified openness to job opportunities.

Next, a first label for the first set of members and a second label for a second set of members that lack job-related activity in the online system are generated (operation 304). For example, the first label includes a positive label of 1, and the second label include a negative label of 0.

Features for the first and second sets of members are inputted with the labels as training data for a machine learning model (operation 306). For example, the features include profile features representing profiles of the members and/or activity features characterizing activity of the members with the online system. The profile features include, but are not limited to, the title, industry, seniority, number of years of experience, number of positions, number of skills, number of companies followed, and/or career length (e.g., the number of days, months, or years of work experience) in each member's profile. The activity features include, but are not limited to, the number of job views, page views, job searches, searches, job applications, messages, profile edits, and/or other types of actions by each member; the recency of each type of action; and/or the number of active members in a network of the member. In turn, the machine learning model is trained to predict the labels based on the corresponding features.

After the machine learning model is trained, the machine learning model is used to classify additional members of the online system as job seekers or non-job-seekers. More specifically, features for an additional member of the online system are determined (operation 308), and the machine learning model is applied to the features to produce a score representing the likelihood that the member is a job seeker (operation 310). For example, the features are obtained and/or derived from profile attributes in the member's profile and/or activity attributes that characterize the member's activity with the online system. The profile attributes and/or activity attributes may be retrieved from one or more data repositories and/or data stores in the online system. The machine learning model includes a gradient boosted tree; after the features are inputted into the gradient boosted tree, the gradient boosted treeoutputs a score ranging from 0 to 1, which represents the probability that the member is actively seeking a new job and/or will engage with job-seeking content or features.

A threshold is applied to the score to generate a classification of the member as job seeker or non-job-seeker (operation 312). For example, the threshold includes a numeric and/or percentile threshold that is compared with the score. If the score meets or exceeds the threshold, the member is classified as a job seeker. If the score fails to meet or exceed the thresholds, the member is not classified as a job seeker.

The classification is then outputted in association with the member (operation 314). For example, a mapping of the member's identifier to the classification is stored or outputted in a database, distributed filesystem, event stream, and/or other data store. The classification and/or score are also, or instead, displayed in conjunction with the member's identifier in a user interface for the online system and/or used to generate a ranking of candidates for a job.

The classification is also, or instead, used to update content outputted in the user interface of the online system by one or more electronic devices. More specifically, the classification is inputted into another machine learning model that predicts a compatibility between the member and one or more jobs (operation 316), and a recommendation related to the member and job(s) is outputted based on the predicted compatibility (operation 318). For example, the classification and/or score from the machine learning model are inputted with additional features for the member and each job into the other machine learning model, and the other machine learning model outputs a match score representing a likelihood of a positive outcome (e.g., click, save, application, etc.) between the member and each job. Recommendations of some or all jobs are then generated by ranking the jobs by descending match score and/or applying another threshold to the match scores.

The recommendations are then used to update the user interface of the online system, which is displayed and/or otherwise provided by electronic devices such as personal computers, laptop computers, table computers, mobile phones, gaming consoles, smart televisions, and/or home assistants. For example, one or more recommendations are outputted to the member in notifications, content feeds, job-related modules, emails, and/or other components of the user interface.

Operations 308-318 are repeated for remaining members (operation 308) of the online system. For example, the machine learning model is used to generate scores, classifications, and/or recommendations for members that cannot be identified as job seekers or non-job-seekers using the rules in operation 302.

Operations 302-306 can also be repeated on a periodic basis and/or based on the availability of new features, labels, and/or rules for identifying job seekers and non-job-seekers. In turn, the latest version of the machine learning model produced by operations 302-306 is used to generate scores and/or classifications of members of the online system as job seekers or non-job-seekers, and the scores and/or classifications are used to improve the functionality, value, and/or performance of the online system with respect to job seeking, hiring, employment, and/or recommendations.

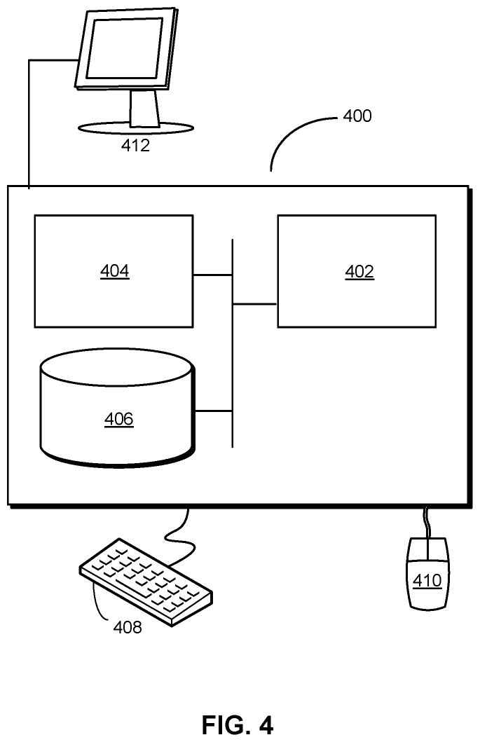

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 includes functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications obtain the use of hardware resources on computer system 400 from the operating system, as well as interact with the user through a hardware and/or software framework provided by the operating system.

In one or more embodiments, computer system 400 provides a system for identifying job seekers. The system includes a sampling apparatus, a model-creation apparatus, and a management apparatus, one or more of which may alternatively be termed or implemented as a module, mechanism, or other type of system component. The sampling apparatus applies one or more rules to features of a first set of members of the online system to identify the first set of members as job seekers. Next, the sampling apparatus generates a first label for the first set of members and a second label for a second set of members that lack job-related activity in the online system. The model-creation apparatus then inputs additional features for the first and second sets of members with the labels as training data for the machine learning model.

The management apparatus determines, based on data retrieved from a data store in an online system, features for a first member of the online system. The features include profile features produced from profile attributes in a profile of the first member and activity features characterizing activity of the first member with the online system. Next, the management apparatus applies the machine learning model to the profile features and activity features to produce a score representing a likelihood that the first member is a job seeker. The system then applies a threshold to the score to generate a classification of the first member as the job seeker or as a non-job-seeker. Finally, the system updates, based on the classification, content outputted in a user interface of the online system by one or more electronic devices.

In addition, one or more components of computer system 400 may be remotely located and connected to the other components over a network. Portions of the present embodiments (e.g., sampling apparatus, model-creation apparatus, management apparatus, data repository, model repository, online network, etc.) may also be located on different nodes of a distributed system that implements the embodiments. For example, the present embodiments may be implemented using a cloud computing system that identifies a set of remote users as job seekers or non-job-seekers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, based on data retrieved from a data store in an online system, profile features produced from profile attributes in a profile of a first member in the online system and activity features produced from activity attributes that characterize activity of the first member with the online system;
applying, by one or more computer systems, a machine learning model to the profile features and the activity features to produce a score representing a likelihood that the first member is a job seeker;
applying, by the one or more computer systems, a threshold to the score to generate a classification of the first member as the job seeker or as a non-job-seeker; and
updating, by the one or more computer systems based on the classification, content outputted in a user interface of the online system by one or more electronic devices.

2. The method of claim 1, further comprising:
applying one or more rules to the activity features of a first set of members of the online system to identify the first set of members as job seekers.

3. The method of claim 2, wherein the one or more rules comprise identifying a job seeker based on a threshold number of job-seeking actions over a pre-specified period.

4. The method of claim 3, wherein the threshold number of job-seeking actions comprises at least one of:
one job application;
one job save;
setting one job alert; and
two job searches.

5. The method of claim 2, wherein the pre-specified period comprises a recent number of weeks.

6. The method of claim 2, wherein the one or more rules comprise identifying a job seeker based on a user-specified openness to job opportunities.

7. The method of claim 2, further comprising:
generating a first label for the first set of members and a second label for a second set of members that lack job-related activity in the online system; and
inputting additional features for the first and second sets of members with the labels as training data for the machine learning model.

8. The method of claim 1, wherein updating, based on the classification, content outputted in the user interface of the online system by one or more electronic devices comprises:
inputting the classification into another machine learning model that predicts a compatibility between the first member and one or more jobs; and
outputting a recommendation related to the first member and the one or more jobs based on the predicted compatibility.

9. The method of claim 1, wherein the profile features comprise at least one of:
a title;
an industry;
a seniority;
a number of positions in the profile;
a number of skills in the profile;
a number of companies followed by the first member; and
a career length.

10. The method of claim 1, wherein the activity features comprise at least one of:
a number of job views;
a number of page views in the online system;
a number of job searches;
a number of searches on the online system;
a number of job applications;
a number of messages;
a number of profile edits;
a recency of an action; and
a number of active members in a network of the first member.

11. The method of claim 1, wherein the machine learning model comprises a gradient boosted tree.

12. A system, comprising:
one or more processors; and
memory storing instructions that, when executed by the one or more processors, cause the system to:
determine, based on data retrieved from a data store in an online system, profile features produced from profile attributes in a profile of a first member in the online system and activity features produced from activity attributes that characterize activity of the first member with the online system;
apply a machine learning model to the profile features and the activity features to produce a score representing a likelihood that the first member is a job seeker;
apply a threshold to the score to generate a classification of the first member as the job seeker or as a non-job-seeker; and
update, based on the classification, content outputted in a user interface of the online system by one or more electronic devices.

13. The system of claim 12, wherein the memory further stores instructions that, when executed by the one or more processors, cause the system to:
apply one or more rules to the activity features of a first set of members of the online system to identify the first set of members as job seekers;
generate a first label for the first set of members and a second label for a second set of members that lack job-related activity in the online system; and
input additional features for the first and second sets of members with the labels as training data for the machine learning model.

14. The system of claim 13, wherein the one or more rules comprise identifying a job seeker based on a threshold number of job-seeking actions over a pre-specified period.

15. The system of claim 14, wherein the threshold number of job-seeking actions comprises at least one of:
one job application;
one job save;
setting one job alert;
two job searches; and
a user-specified openness to job opportunities.

16. The system of claim 12, wherein the memory further stores instructions that, when executed by the one or more processors, cause the system to:
input the classification into another machine learning model that predicts a compatibility between the first member and one or more jobs; and
output a recommendation related to the first member and the one or more jobs based on the predicted compatibility.

17. The system of claim 12, wherein the profile features comprise at least one of:
a title;
an industry;
a seniority;
a number of positions in the profile;
a number of skills in the profile;
a number of companies followed by the first member; and
a career length.

18. The system of claim 12, wherein the activity features comprise at least one of:
a number of job views;
a number of page views in the online system;
a number of job searches;
a number of searches on the online system;
a number of job applications;
a number of messages;
a number of profile edits;
a recency of an action; and
a number of active members in a network of the first member.

19. A non-transitory computer-readable storage medium storing instructions that when executed by a computer cause the computer to perform a method, the method comprising:
determining, based on data retrieved from a data store in an online system, profile features produced from profile attributes in a profile of a first member in the online system and activity features produced from activity attributes that characterize activity of the first member with the online system;
applying a machine learning model to the profile features and the activity features to produce a score representing a likelihood that the first member is a job seeker;
applying a threshold to the score to generate a classification of the first member as the job seeker or as a non-job-seeker; and
updating, based on the classification, content outputted in a user interface of the online system by one or more electronic devices.

20. The non-transitory computer readable storage medium of claim 19, the method further comprising:
applying one or more rules to the activity features of a first set of members of the online system to identify the first set of members as job seekers;
generating a first label for the first set of members and a second label for a second set of members that lack job-related activity in the online system; and
inputting additional features for the first and second sets of members with the labels as training data for the machine learning model.
